(19) United States
(12) Patent Application Publication
(10) Pub. No.: US 2012/0156390 A1
(43) Pub. Date: Jun. 21, 2012

(54) MULTI-ANGLE HARD BIAS DEPOSITION FOR OPTIMAL HARD-BIAS DEPOSITION IN A MAGNETIC SENSOR

(75) Inventors: Satoru Araki, San Jose, CA (US); Shin Funada, Pleasanton, CA (US); Insik Jin, Morgan Hill, CA (US); Quang Le, San Jose, CA (US); Simon H. Liao, Fremont, CA (US); Chang-Man Park, Mountain View, CA (US)

(73) Assignee: Hitachi Global Storage Technologies Netherlands B.V., Amsterdam (NL)

(21) Appl. No.: 12/975,084

(22) Filed: Dec. 21, 2010

(51) Int. Cl. B05D 3/06; B05D 3/10; B05D 5/00

(52) U.S. Cl. 427/534; 427/131; 427/595

(57) ABSTRACT

A method for manufacturing a magnetic sensor that result in improved magnetic bias field to the sensor, improved shield to hard bias spacing and a flatter top shield profile. The method includes a multi-angled deposition of the hard bias structure. After forming the sensor stack a first hard bias layer is deposited at an angle of about 70 degrees relative to horizontal. This is a conformal deposition. Then, a second deposition is performed at an angle of about 90 degrees relative to horizontal. This is a notching deposition, that results in notches being formed adjacent to the sensor stack. Then, a hard bias capping layer is deposited at an angle of about 55 degrees relative to horizontal. This is a leveling deposition that further flattens the surface on which the top shield can be electroplated.

### FIELD OF THE INVENTION

The present invention relates to magnetoresistive sensors and more particularly to a method for manufacturing a sensor that optimizes hard bias to free layer alignment while also producing a flat shield and optimizing hard bias to shield spacing.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresisive (TMR) sensor can be employed to read a magnetic signal from the magnetic media. The sensor includes a nonmagnetic conductive layer (if the sensor is a GMR sensor) or a thin, nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

### SUMMARY OF THE INVENTION

The present invention provides a method for manufacturing a magnetic sensor that result in improved magnetic bias field to the sensor, improved shield to hard bias spacing and a flatter top shield profile. The method includes a multi-angled deposition of the hard bias structure.

After forming the sensor stack, a hard bias seed is first deposited. Then, a first hard bias layer is deposited at an angle of less than 90 degrees relative to horizontal, or more preferably 60-80 degrees or about 70 degrees relative to horizontal. This is a conformal deposition. Then, a second deposition is performed at an angle of about 90 degrees relative to horizontal. This is a notching deposition that results in notches being formed adjacent to the sensor stack. Then, a hard bias capping layer is deposited at an angle of about 55 degrees relative to horizontal. This is a leveling deposition that forms a flat surface on which the top shield can be electroplated.

The hard bias seed layer can be NiTa/CrMo, Ta/Cr, Cr, CrMo and CrTi. The first and second hard bias layers can be constructed of CoPt or CoPtCr, and the hard bias capping layer can be constructed of a layer of Ta and a layer consisting of Cr, Ir, Rh, Ru, NiCr, CrMo or NiTa. These layers can be deposited by ion beam deposition.

The first layer, deposited at an angle that results in a conformal deposition, ensures that the sides of the sensor stack are well coated with hard bias material, with no voids or imperfections being present at the interface between the first hard bias layer and the sensor stack. The second deposition is deposited at an angle that causes the deposited layer to be formed with notches adjacent to the sides of the sensor stack. That is, the level of the hard bias actually drops slightly at the sides of the sensor stack. This ensures that the hard bias does not slope upward at the sensor stack, which would cause loss of bias field to the shield, and would also result in a poorly defined top shield with a non-planar bottom interface. The deposition of the hard bias capping layer is performed at a leveling angle that fills the slight notch formed by the second hard bias layer and provides a very flat surface on which to form the top shield.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an ABS view of an example of a magnetoresistive sensor that might be constructed by a method of the present invention;

FIG. 4 shows an ABS view of prior art magnetoresisetive sensor; and

FIGS. 5-12 are views of a magnetoresistive sensor in various intermediate stages of manufacture, illustrating a method of manufacturing a magnetoresistive sensor according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive Concepts claimed herein.

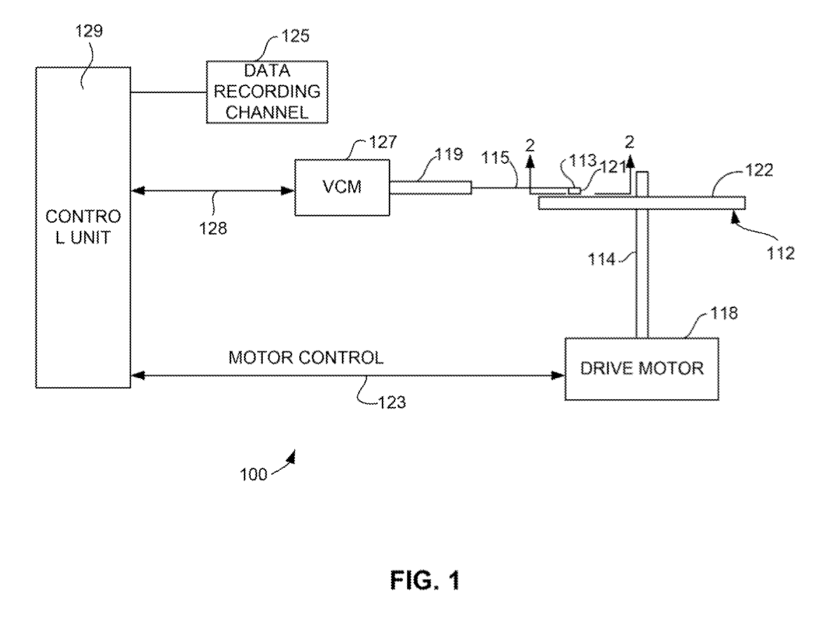

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

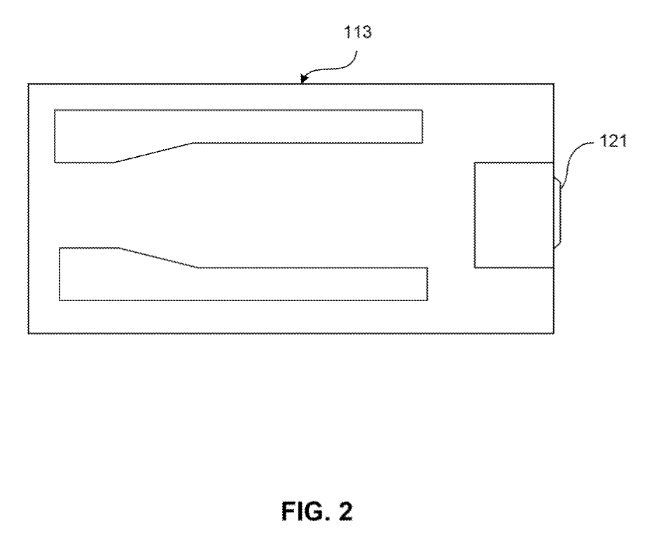

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

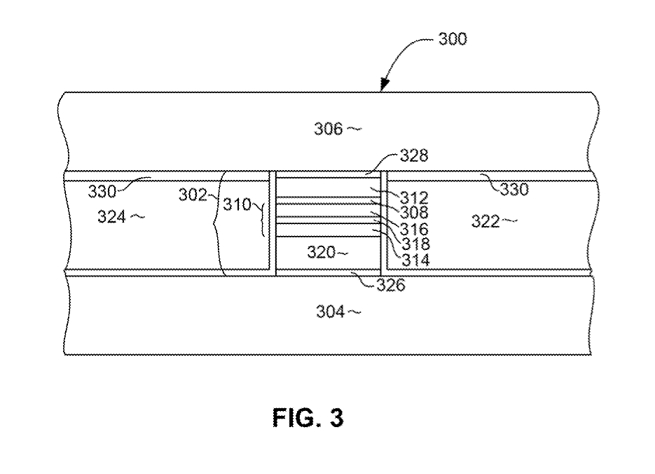

FIG. 3 shows an example of a magnetoresistive sensor structure 300 that could be constructed according to a method of the present invention. The sensor structure 300 is seen as viewed from the air bearing surface (ABS). The sensor 300 includes a sensor stack 302 that is sandwiched between first and second, electrically conductive, magnetic shields 304, 306 that also function as electrically conductive leads.

The sensor stack 302 can include a non-magnetic layer 308 that is sandwiched between a magnetic pinned layer structure 310 and a magnetic free layer structure 312. The non-magnetic layer 308 can be an electrically conductive material, if the sensor 300 is a Giant Magnetoresistive (GMR) sensor, and can be a thin electrically insulating material layer if the sensor structure 300 is a Tunnel Junction Sensor (TMR).

The pinned layer structure 310 can include first and second magnetic layers 314, 316 with a non-magnetic, antiparallel coupling layer such as Ru 318 sandwiched between the first and second magnetic layers 314, 318 The first magnetic layer 314 has its magnetization pinned in a first direction perpendicular to the ABS. This pinning is a result of exchange coupling with a layer of antiferromagnetic material 320 such as IrMn. The second magnetic layer 316 has its magnetization pinned in a second direction that is antiparallel with the first direction as a result of antiparallel coupling between the first and second magnetic layers 314, 316 across the antiparallel coupling layer 318.

The magnetic free layer 312 has a magnetization that is biased in a direction that is generally parallel with the ABS, but that is free to move in response to a magnetic field. The biasing of the free layer is provided by a magnetostatic coupling with first and second hard magnetic bias layers 322, 324. One or more seed layers 326 may be provided at the bottom of the sensor stack 302 in order to ensure a desired grain growth of the other layers of the sensor stack 302 deposited thereon. In addition a capping layer such as Ta 328 may be provided at the top of the sensor stack to protect the underlying layers during manufacture. In addition, thin insulation layers 330 is provided at either side of the sensor stack 302 and across at least the bottom lead/shield 304 in order to prevent sense current from being shunted through the magnetic bias layers 322, 324. In addition, the hard bias structures 322 also have flat upper surfaces. A non-magnetic hard bias cap layer 330 is provided at the top of each of the hard bias layers 322, 324 to provide magnetic spacing between the hard bias layers 322, 324 and the shield 306.

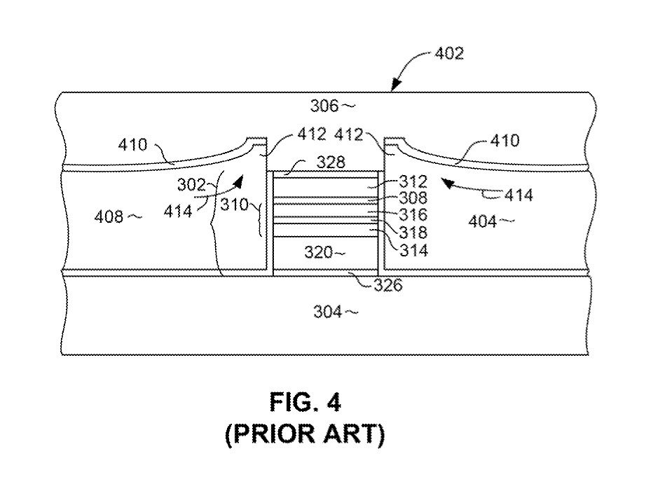

FIG. 4 shows a magnetic read sensor 402 produced by a prior art process. As can be seen, the hard bias layers 404, 408 curve upward into the shield 306 to form peaks 412 at the sides of the sensor stack. The magnetization of the hard bias layers 404, 408 also curves upward toward the shield, as indicated by arrows 414, causing a significant loss of bias field to the shield 306, and also causing a deviation in magnetization direction away from a desired direction parallel with the free layer 312. This structure also results in a poorly defined bottom interface of the shield 306, which causes the gap thickness of the sensor 402 to be poorly defined.

As can be seen in FIG. 3, a magnetic sensor of the present invention has a magnetic shield 306 that has a smooth, flat bottom interface, and the bias layers 322, 324 have flat upper surfaces. This structure will be described in much greater detail below along with a description of a method for manufacturing a magnetic sensor according to an embodiment of the invention. The magnetic sensor 300 provides optimal spacing between the hard bias layers 322, 324 and the shield. This optimal shield to hard bias spacing along with the flat upper surfaces of the hard bias layers 322, 324 prevents hard bias field from being lost to the shield 306, thereby optimizing the biasing of the magnetization of the free layer 312, as will be described in greater detail herein below.

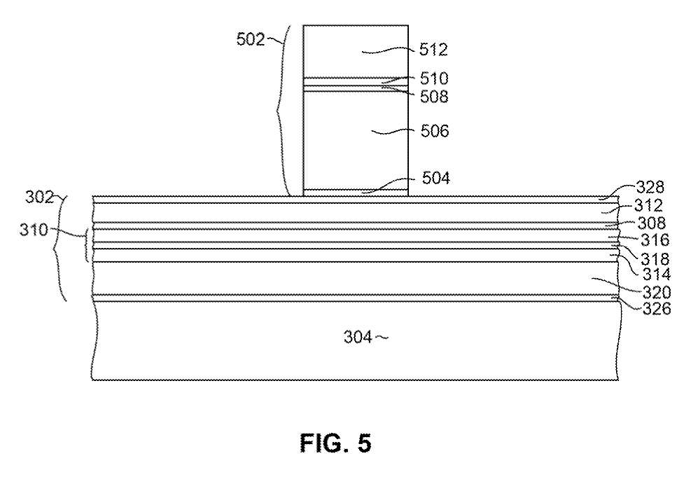

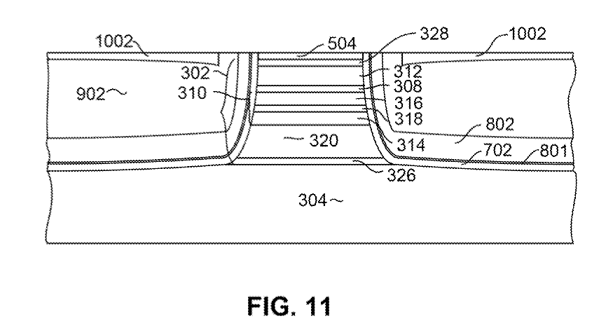

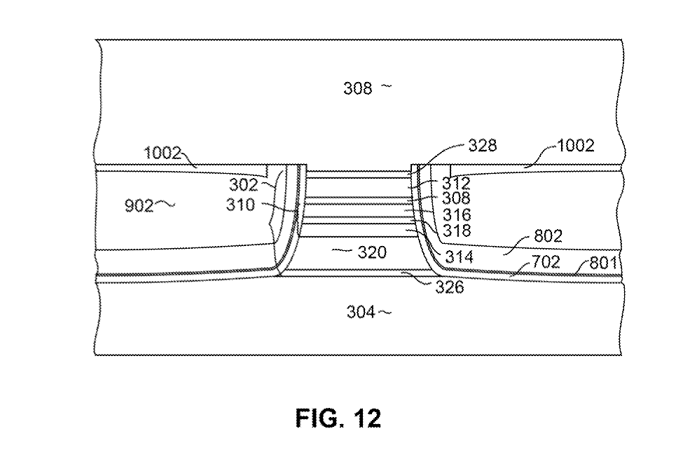

FIGS. 5-12 illustrate a method of manufacturing a magnetic sensor according to an embodiment of the invention. With particular reference to FIG. 5, a series of sensor layers 302 is deposited over a substrate 304. The series of sensor layers 302 can include the layers 326, 320, 314, 318, 316, 308, 312, 328 described above. However, this is by way of example only, as other sensor structures would be possible as well.

A mask structure 502 is formed over the sensor layers 302. The mask structure can be of various configurations. By way of example, the mask 502 can include a hard mask layer 504 such as Diamond Like Carbon (DLC) formed directly on the top of the sensor layers 302, an image transfer layer 506 formed of a soluble polyimide material such as DURIMIDE® formed over the hard mask 504, and a photoresist mask 512 formed over the image transfer layer 506. The photoresist mask is defined by a photolithographic process, and the image of the photoresist mask is transferred onto the underlying layers 506, 504 by one or more processes such as reactive ion etching and/or ion milling, leaving a structure as shown in cross section in FIG. 5.

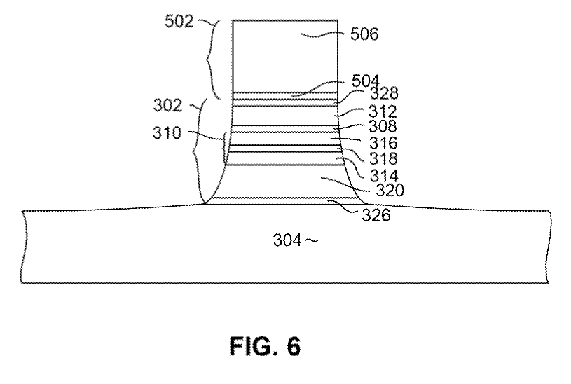

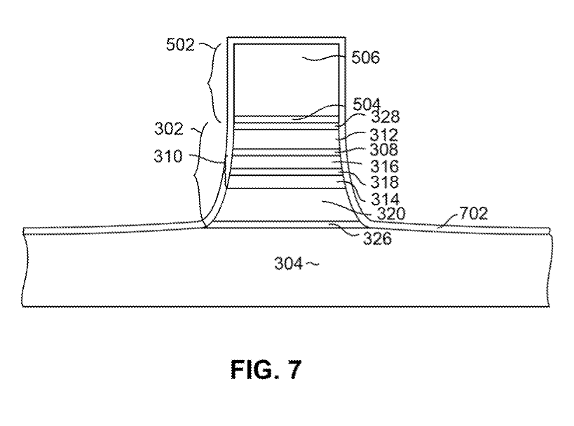

After the mask 502 has been defined, an ion milling is performed to remove portions of the sensor layers 302 that are not protected by the mask 502, leaving a structure as shown in FIG. 6. It can be seen that a portion of the mask 502 is consumed by the ion milling. A thin layer of non-magnetic, electrically insulating material (preferably alumina) 702 is deposited leaving a structure as shown in FIG. 7. This layer 702 is preferably deposited by a conformal deposition process such as atomic layer deposition or chemical vapor deposition (preferably atomic layer deposition), and can be deposited as thin as possible ˜30A or less without pin-holes.

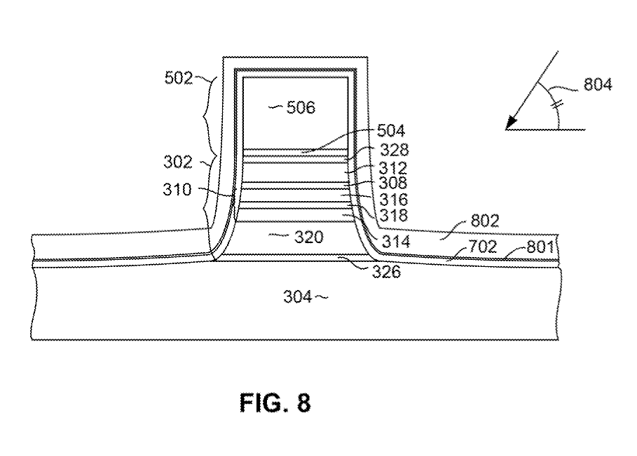

A hard bias seed layer 801 is deposited on the insulation layer. This seed layer 801 can be a layer or layers that can include materials such as NiT and/or CrMo. Then, with reference to FIG. 8 a first layer of magnetic hard bias material 802 is deposited at a first deposition angle 804. This material 802 is preferably CoPt, although it could be another material such as CoPtCr or some other hard magnetic material. The layer 802 is deposited as a conformal deposition by ion beam deposition, at an angle 804 of 60-80 degrees or about 70 degrees relative to horizontal (i.e. relative to the plane of the surface of the wafer (not shown) or relative to the plane of the as deposited layers or relative to the plane of the shield 304). This first deposition at the above described angle results in an excellent conformal deposition of the hard bias material 802 on the sides of the sensor stack 302. This ensures an even application of hard bias material at the sides of the sensor stack 302 with no voids or defects in the deposited hard bias material.

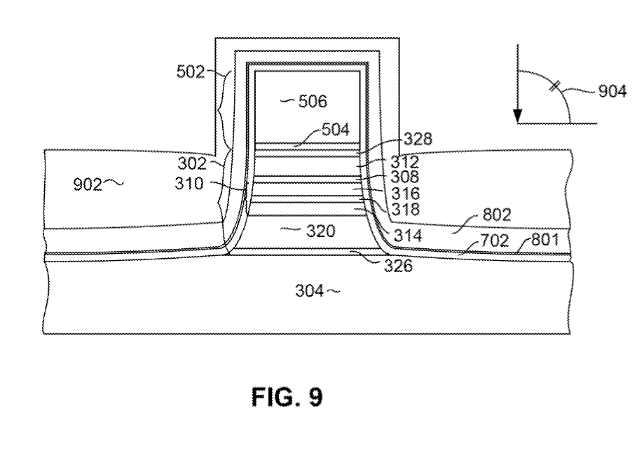

With reference now to FIG. 9, a second hard bias deposition is performed to deposit a second layer of hard magnetic material (second hard bias layer) 902 which is preferably CoPt but could be some other material such as CoPtCr. Like the previous deposition, this second deposition is preferably performed by ion beam deposition. However, this deposition is preferably performed as a notching deposition at an orientation that is near normal to the wafer and to the as deposited layers. As such, the deposition of layer 902 is performed at an angle 904 of 80-100 degrees or about 90 degrees relative to horizontal (i.e. relative to the plane of the wafer or relative to the planes of the as deposited layers such as the plane of the surface of the shield 304).

As can be seen, this second deposition results in the formation of notches 904 at the corners near the sensor stack 302. This prevents the hard bias layer 902 from curving upward at the sensor stack 302. This, provides a straight line of magnetic field to the sensor stack, preventing the hard bias field from curving upward at the sensor stack 302 (as was the case with the magnetic field 414 of the prior art sensor 402 of FIG. 4), thereby minimizing the loss of bias field to the shield as will be seen. This also provides a very flat surface on which to form the shields, as will be seen.

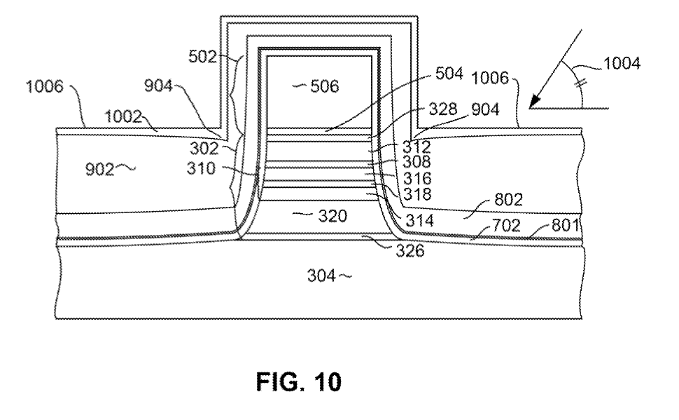

In one approach, an ion milling is performed at a glancing angle (near horizontal) to remove portions of the 802 and 902 from the sides of the remaining image transfer layer 506 to remove excess hard bias layer (refer to as hard bias tip mill). Then, with reference now to FIG. 10, a non-magnetic capping layer 1002 is deposited. This layer 1002 is preferably Ta, Cr, Rh, Ru, Ir, NiTa, CrMo or a combination of these materials, and is preferably deposited by ion beam deposition at an angle 1004 of 50 to 60 degrees or about 55 degrees relative to horizontal (i.e. relative to the plane of the wafer or relative to the as deposited layers). This angle 1004 can be referred to as a leveling angle deposition, because deposition at this angle fills in the slight notches 904 to provide an extremely flat upper surface 1006 on the capping layer 1002 at either side of the sensor stack 302. After the capping layer 1002 is deposited, DLC is deposited, followed by liftoff with NMP and chemical mechanical polishing (CMP) to remove overburden materials and stencils.

In another approach, the first approach will omit tip mill and proceed with hard-bias cap deposition and then to DLC deposition and follow by NMP and CMP to remove overburden materials and stencils.

Afterward, a RIE step is done to remove both the first and second DLC and to leave the capping layer 328 exposed. An additional seed layer consisting of Ru, Rh, or Ir and NiFe or CoFe, or their alloys are deposited, followed by an electroplating process to form the upper shield 308 over the sensor capping layer 328 and the hard bias capping layer 1002. As can be seen, this process provides an excellent flat surface on which to form the shield 308, resulting in a very flat bottom interface for the shield. This provides a well controlled, uniform, thick magnetic spacing between the hard bias layer and the shield 308 and maximizes magnetic biasing to the free layer 312. The resulting flat bottom of the shield also provides a well controlled gap thickness for defining a small bit length for improved data density.

While various embodiments have been described above, it should be understood that they have been presented by way of example only and not limitation. Other embodiments falling within the scope of the invention may also become apparent to those skilled in the art Thus, the breadth and scope of the invention should not be limited by any of the above-described exemplary embodiments, but should be defined only in accordance with the following claims and their equivalents.

What is claimed is:

1. A method for manufacturing a magnetic sensor, comprising:
forming a magnetic shield having a surface;
forming a sensor stack over the magnetic shield the sensor stack having first and second laterally opposed sides;
depositing a non-magnetic, electrically insulating layer over the first and second sides of the sensor stack and the magnetic shield;
depositing a first hard bias layer, the first hard bias layer being deposited at a deposition angle of 60-80 degrees relative to the surface of the magnetic shield; and
depositing a second hard bias layer, the second hard bias layer being deposited at a deposition angle that is 80-100 degrees relative to the surface of the magnetic shield.

2. The method as in claim 1 wherein the deposition of the first and second hard bias layers are performed using ion beam deposition.

3. The method as in claim 1 wherein the shield and sensor stack are formed on a wafer, and wherein the angles of deposition of the first and second hard bias layers are measured relative to a surface of the wafer.

4. The method as in claim 1 wherein the first and second hard bias layers each comprise CoPt.

5. The method as in claim 1 wherein the non-magnetic, electrically insulating layer is deposited by a conformal deposition method.

6. The method as in claim 1 wherein the non-magnetic, electrically insulating layer is deposited by atomic layer deposition.

7. The method as in claim 1 wherein the non-magnetic, electrically insulating layer is deposited by chemical vapor deposition.

8. The method as in claim 1 wherein the first hard bias layer is deposited at an angle of about 70 degrees relative to the surface of the magnetic shield and the second hard bias layer is deposited at an angle of about 90 degrees relative to the surface of the magnetic shield.

9. The method as in claim 1 wherein the deposition of the first hard bias layer is a conformal deposition and the deposition of the second hard bias layer is a notching deposition.

10. A method for manufacturing a magnetic sensor, comprising:
forming a magnetic shield having a surface;
forming a sensor stack over the-magnetic shield the sensor stack having first and second laterally opposed sides;
depositing a non-magnetic, electrically insulating layer over the first and second sides of the sensor stack and the magnetic shield;
depositing a first hard bias layer, the first hard bias layer being deposited at a deposition angle of 60-80 degrees relative to the surface of the magnetic shield;
depositing a second hard bias layer over the first hard bias layer, the second hard bias layer being deposited at a deposition angle that is 80-100 degrees relative to the surface of the magnetic shield; and
depositing a non-magnetic hard bias capping layer over the second hard bias layer, the non-magnetic capping layer being performed at an angle of 50-60 degrees relative to the surface of the magnetic shield.

11. The method as in claim 10, wherein the first and second hard bias layer comprise CoPt and the hard bias capping layer comprises Ta.

12. The method as in claim 10, wherein the first and second hard bias layers comprise CoPt and the hard bias capping layer comprises a Cr.

13. The method as in claim 10, wherein the first and second hard bias layers comprise CoPt and the hard bias capping layer comprises a layer of Ta and a layer of Cr.

14. The method as in claim 10, wherein the first and second hard bias layers and the hard bias capping layer are all deposited by ion beam deposition.

15. The method as in claim 10 wherein the shield and sensor stack are formed on a wafer, and wherein the angles of deposition of the first and second hard bias layers are the hard bias capping layer are measured relative to a surface of the wafer.

16. The method as in claim 10, wherein the deposition of the first hard bias layer is a conformal deposition, the deposition of the second hard bias layer is a notching deposition and the deposition of the hard bias capping layer is a leveling deposition.

17. The method as in claim 10, wherein the non-magnetic, electrically insulating layer is alumina, deposited by atomic layer deposition.

18. A method for manufacturing a magnetic sensor, comprising:
forming a magnetic shield having a surface;
depositing a series of sensor layers over the magnetic shield;
forming a mask structure over the series of sensor layers;
performing an ion milling to remove a portion of the series of sensor layers that is not protected by the mask structure to form a sensor stack having first and second laterally opposed sides;
depositing a non-magnetic, electrically insulating layer over the first and second sides of the sensor stack and the magnetic shield;
depositing a first hard bias layer, the first hard bias layer being deposited at a deposition angle of 60-80 degrees relative to the surface of the magnetic shield;
depositing a second hard bias layer over the first hard bias layer, the second hard bias layer being deposited at a deposition angle that is 80-100 degrees relative to the surface of the magnetic shield;
depositing a non-magnetic capping layer over the second hard bias layer, the non-magnetic capping layer being performed at an angle of 50-60 degrees relative to the surface of the magnetic shield;
removing the mask structure; and
forming a second magnetic shield over the sensor stack and hard bias capping layers.

19. The method as in claim 18 wherein mask structure includes a hard mask and an image transfer layer, and wherein the removal of the mask structure comprises:
performing a glancing angle ion milling to remove portions of the non-magnetic, electrically insulating layer, first and second hard bias layers and hard bias capping layer from first and second sides of the mask structure,
performing a chemical liftoff process to remove the image transfer layer; and
performing a reactive ion etching to remove the hard mask, layer.

20. The method as in claim 18 wherein the first and second hard bias layers comprise CoPt and the hard bias capping layer comprises a layer of Ta and a layer of Cr.

21. The method as in claim 18 wherein the deposition of the first and second hard bias layers and the hard bias capping layer are performed by ion beam deposition.

22. The method as in claim 18 wherein the deposition of the first hard bias layer is a conformal deposition, the deposition of the second hard bias layer is a notching deposition, and the deposition of the hard bias capping layer is a leveling deposition.
